(19) United States
(12) Patent Application Publication
(10) Pub. No.: US 2026/0073165 A1
(43) Pub. Date: Mar. 12, 2026

(54) RADIO FREQUENCY IDENTIFICATION (RFID) TAG LOCALIZATION USING SYNCHRONIZED PHASE-BASED RANGING WITH CHANNEL HOPPING

(71) Applicant: QUALCOMM Incorporated, San Diego, CA (US)

(72) Inventors: Paul Dominic HISCOCK, Cambridge (GB); Joseph Patrick BURKE, Carlsbad, CA (US); Sumit AGRAWAL, San Diego, CA (US); Sheng-Yuan TU, San Diego, CA (US)

(21) Appl. No.: 18/882,565

(22) Filed: Sep. 11, 2024

(51) Int. Cl. G06K 7/10

(52) U.S. Cl. CPC G06K 7/10128

(57) ABSTRACT

Systems and techniques are provided for wireless communications. A wireless communication device can obtain information indicative of a configured sequence of carrier frequencies associated with phase-based ranging (PBR) distance estimation between the wireless communication device and a Radio Frequency Identification (RFID) tag. An RFID Query command transmitted from a first RFID reader device to the RFID tag can be detected. A pilot tone can be sequentially transmitted to the RFID tag on each respective carrier frequency of the configured sequence, using a corresponding plurality of frequency hops synchronized between at least the wireless communication device and the first RFID reader device. A PBR measurement can be determined, indicative of an estimated distance from the wireless communication device to the RFID tag based on relative phase measurement associated with a backscatter signal received from the RFID tag for each respective carrier frequency of the configured sequence of carrier frequencies.

### FIELD OF THE DISCLOSURE

The present disclosure generally relates to wireless communications. For example, aspects of the present disclosure relate to RFID ranging, and more particularly relate to RFID tag localization using a plurality of RFID reader devices with synchronized frequency hopping sequences for phase-based ranging (PBR).

### BACKGROUND

Short range wireless communication enables wireless communication over relatively short distances (e.g., within thirty meters). For example, Radio Frequency Identification (RFID) systems can be used to perform short range wireless communication based on the wireless transfer of data between a reader (e.g., RFID reader device) and a tag or transponder (e.g., RFID tag). RFID systems can be used for identification, tracking, data storage, etc. For example, RFID systems can be used to identify and/or track various items, such as warehouse boxes or consumer products.

An RFID tag may be attached to an item to be tracked and may include data storage and an antenna. The data storage stores information corresponding to the associated item, such as a product name, a serial number, product information, a manufacturer, etc. The antenna enables the RFID tag to be read by an RFID reader, which transmits an interrogating signal to one or more RFID tags within communication range. RFID tags can be passive, active, semi-passive or semi-active. Passive RFID tags utilize the interrogating signal from an RFID reader to power a transmission by or from the RFID tag. Active, semi-passive and semi-active RFID tags can include a power source or battery, which can be used to power a transmission by or from the RFID tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method of wireless communications is provided, the method comprising: obtaining information indicative of a configured sequence of carrier frequencies associated with phase-based ranging (PBR) distance estimation between a wireless communication device and a Radio Frequency Identification (RFID) tag; detecting an RFID Query command transmitted from a first RFID reader device to the RFID tag; transmitting a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and determining a PBR measurement indicative of an estimated distance from the wireless communication device to the RFID tag based on relative phase measurement associated with a backscatter signal received from the RFID tag for each respective carrier frequency of the configured sequence of carrier frequencies.

In another example, an apparatus for wireless communications is provided. The apparatus includes at least one memory and at least one processor coupled to the at least one memory and configured to: obtain information indicative of a configured sequence of carrier frequencies associated with phase-based ranging (PBR) distance estimation between the wireless communication device and a Radio Frequency Identification (RFID) tag; detect an RFID Query command transmitted from a first RFID reader device to the RFID tag; transmit a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and determine a PBR measurement indicative of an estimated distance from the wireless communication device to the RFID tag based on relative phase measurement associated with a backscatter signal received from the RFID tag for each respective carrier frequency of the configured sequence of carrier frequencies.

In another example, a non-transitory computer-readable medium is provided that includes instructions that, when executed by at least one processor, cause the at least one processor to: obtain information indicative of a configured sequence of carrier frequencies associated with phase-based ranging (PBR) distance estimation between the wireless communication device and a Radio Frequency Identification (RFID) tag; detect an RFID Query command transmitted from a first RFID reader device to the RFID tag; transmit a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and determine a PBR measurement indicative of an estimated distance from the wireless communication device to the RFID tag based on relative phase measurement associated with a backscatter signal received from the RFID tag for each respective carrier frequency of the configured sequence of carrier frequencies.

In another example, an apparatus for wireless communications is provided. The apparatus includes: means for obtaining information indicative of a configured sequence of carrier frequencies associated with phase-based ranging (PBR) distance estimation between a wireless communication device and a Radio Frequency Identification (RFID) tag; means for detecting an RFID Query command transmitted from a first RFID reader device to the RFID tag; means for transmitting a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and means for determining a PBR measurement indicative of an estimated distance from the wireless communication device to the RFID tag based on relative phase measurement associated with a backscatter signal received from the RFID tag for each respective carrier frequency of the configured sequence of carrier frequencies.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating example components of a device, in accordance with some examples;

FIG. 3 is a diagram illustrating an example of an RFID system, in accordance with some examples;

FIG. 4A is a diagram illustrating an example of an RFID system that can be used for phase-based ranging (PBR) distance estimation, in accordance with some examples;

FIG. 4B is a diagram illustrating an example of PBR-based distance estimation using a plurality of RFID phase measurements, in accordance with some examples;

FIG. 5 is a diagram illustrating an example of RFID tag localization using synchronized phase-based ranging with respective carrier frequency hopping sequences implemented by a plurality of RFID reader devices, in accordance with some examples;

FIG. 6 is a diagram illustrating another example of RFID tag localization using synchronized phase-based ranging with respective carrier frequency hopping sequences implemented by a plurality of RFID reader devices, in accordance with some examples;

FIG. 7 is a diagram illustrating an example of an RFID system for determining container contents or RFID item inventory information using a plurality of RFID readers with respective synchronized carrier frequency hopping sequences for PBR-based distance estimation and item localization, in accordance with some examples;

FIG. 8 is a flowchart diagram illustrating an example of a process for wireless communications, in accordance with some examples; and

FIG. 9 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Radio Frequency Identification (RFID) systems can be used for short range wireless communication between a reader device (e.g., RFID reader) and one or more tags or transponders (e.g., RFID tags). An RFID reader may also be referred to as an “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by backscattering (e.g., reflecting back) and/or transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.).

An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader, and can use the identification information to determine the tagged items or products that are nearby to the RFID reader.

In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

RFID systems can be used in a retail environment for purposes such as inventory tracking (e.g., determining when items are removed from shelves, which particular items are removed from shelves and the quantity thereof, etc.). RFID systems can also be used in a retail environment for determining the contents of a container (e.g., a basket, box, or other type of container of a consumer or person shopping for items), for instance based on reading the RFID tags of items as they are placed in the container, reading the RFID tags of the items once they are within the container, reading the RFID tags of the items during the checkout process or as the final collection of items is removed from the container, etc. As used herein, a “container” can refer to any receptacle or volume within which items are placed for temporary storage and/or transport (e.g., prior to purchase of the items). For example, a container can include various implementations, such as a basket (e.g., a handheld basket), a cart or trolley, a bag or satchel, a box, etc. A “container” or “container contents” may also refer to the hand carry of one or more items carried by a person. In some aspects, a container or container volume may refer to a car, vehicle, automobile, etc., having a receptable or volume within which items are placed for temporary storage and/or transport (e.g., including for transportation to and/or from a retail environment or other point of sale of the RFID-tagged items, etc.).

RFID readers can be configured to read hundreds of RFID tags per second, based on the respective RFID tags responding to an interrogation signal from the RFID reader using a corresponding time slot determined for the respective RFID tag. The time slot used by an RFID tag may be assigned by the RFID reader, or may be determined by the RFID tags. For example, RFID tags can respond to an interrogation signal based on randomly choosing a time slot within a configured time window for response. In some cases, an anti-collision algorithm can be used to divide a time window into a plurality of discrete time slots for RFID tags responses, within which each RFID tag may randomly choose or be assigned a particular time slot. Each RFID tag transmits its identification information back to the reader in the corresponding or allocated time slot for the RFID tag. Restricting each RFID tag to a particular time slot reduces the chances of a collision occurring when two or more RFID tags attempt to transmit during the same time slot. If a collision occurs, the multiple RFID tags attempting to transmit during the same time slot are not successfully read by the RFID reader, and may be configured to select new time slots and retransmit.

RFID systems may commonly be implemented without the capability to perform selective reporting. Selective reporting can be associated with an RFID reader that reports only information associated with RFID tags of interest, where the RFID tags of interest are a subset within a larger plurality of RFID tag reflections that are read by the RFID reader. For example, a non-selective RFID reader will report the reflected information read for any RFID tag that is within range to respond to the interrogation signal(s) from the reader. A selective RFID reader can perform selective reporting to filter the reflected information received from a plurality of RFID tags and report only the corresponding information associated with a subset of interest. However, the selective reporting of RFID tag identification information does not suppress RFID tags that are not of interest (e.g., not included in the subset of interest) from responding to the interrogation signal (e.g., the RFID tags not of interest will still respond and consume a time slot). Additionally, in some examples it can be difficult or impossible to determine in advance which RFID tags belong to the subset of interest and which RFID tags do not belong to the subset of interest. For example, in use cases such as a determination of contents in a container of a person shopping (e.g., identifying the products placed into a shopper's basket in a store), a primary task for which the RFID system is utilized may be to determine the subset of interest comprising RFID tags of items selected for purchase by the person and placed into the container.

In some cases, an RFID system can utilize one or more RFID readers (e.g., energizers) with antenna configurations that are adjusted to limit the reading range and/or reading zone. For example, an RFID reader can be configured with a reading zone that corresponds to an angular section of an omnidirectional or 360° reading zone. The selective reading of RFID tags based on antenna configurations of an RFID reader can be challenging when the spatial relationship between the RFID reader(s) and the RFID tag(s) is unknown and/or changing. For example, in a container content determination example, the relative spatial positions of the RFID reader and the RFID tags in a container (e.g., a shopper's basket) can vary, and/or the relative spatial positions of the RFID reader and the RFID tags of items in an environment (e.g., items located on shelves in a store) can vary.

In some examples, selective RFID tag reading can be performed based on measuring the respective signal strength of reply transmissions received by an RFID reader from nearby RFID tags (e.g., the nearby RFID tags receiving an energizing or interrogation signal from the RFID reader). In one illustrative example, the systems and techniques can be configured to determine a respective Received Signal Strength Indicator (RSSI) value for each reflected signal received from an RFID tag (e.g., passive RFID tag) in response to an energizing signal used by the RFID reader to interrogate and scan nearby tags. The RSSI value can be indicative of the power level of the reflected signal received by an antenna of the RFID reader, where a larger RSSI value corresponds to a stronger reflected signal.

In some cases, RFID ranging or distance estimation between the RFID reader and a plurality of RFID tags can be implemented based on the respective RSSI value determined for the reflected signal(s) from each RFID tag, where a larger RSSI value is associated with a shorter distance between the RFID reader and the corresponding RFID tag. For example, based on a placement of the RFID reader (e.g., energizer) on, within, or nearby to the container, one or more signal strength thresholds can be used to filter the RFID tag identification information of the contents in the container from the background noise of unwanted RFID tags corresponding to items in the environment (e.g., items on the shelves) or otherwise not within the container contents.

In some cases, an RFID system can be used to determine the contents of the container (e.g., RFID tags within the container volume) and/or can be used to determine the contents outside of the container (e.g., RFID tags not within the container volume). In some cases, the RFID reader (e.g., energizer) can be integrated with the container, can be configured as a smartphone or UE (e.g., of the person, such as a shopper), etc. Based on determining that the RSSI of the reflected signal from a respective RFID tag is greater than a configured (e.g., pre-determined) threshold, the item corresponding to the identification information of the respective RFID tag can be included in the contents of the container.

The location accuracy of RSSI-based location or ranging estimates can be relatively low, for example on the order of 5-10 meter (m) accuracy. In a retail environment (or other densely populated RFID environment), a 5-10 m location and ranging accuracy can be insufficient to perform reliable and accurate inventory estimation for RFID tagged items. For example, a 5-10 m location and ranging accuracy may be insufficient for estimating the contents in a container (e.g., items in a shopping basket), as both the container contents and the surrounding shelves of RFID tagged products or items fall within the radius of error or uncertainty associated with the RSSI-based ranging estimate.

When the location and ranging accuracy of an RFID-based ranging estimate is larger than the area or volume of interest for the selective reading of RFID tags (e.g., such as when the location and ranging accuracy of an RFID-based ranging estimate is larger than the area or volume of a container, such as a shopper's basket), various RFID tagged items may incorrectly be included and/or excluded from the estimated item inventory of the contents in the container (also referred to herein as container content item inventory or basket content item inventory). For example, with a 5-10 m ranging accuracy for RSSI-based selective RFID reading, one or more items on nearby portions of the environment (e.g., nearby store shelves) or in other containers (e.g., other shoppers' baskets) may incorrectly be included in the estimated item inventory of a different person (e.g., a different shopper). In another example, one or more items that are located within contents in the container (e.g., basket item inventory) may incorrectly be excluded from the estimated item inventory for that person (e.g., the shopper using the container).

There is a need for systems and techniques that can be used to perform selective reading of RFID tags with improved accuracy, for example to determine contents in a container or item inventory associated with a user (e.g., to determine contents in container, such as a shopper's basket contents, to determine contents outside of or not within the container, etc.), without a priori information of a selected subset of RFID tags of interest. There is a further need for systems and techniques that can be used to perform selective reading of RFID tags to determine contents in a container (e.g., the items placed within a shopper's basket in a store or retail environment) through the recording of collected items' RFID identification information. There is a need for systems and techniques that can be used to perform selective RFID tag reading for container content determination prior to checkout and/or without using spatial isolation between tags of interest and tags not of interest. For example, there is a need for selective RFID tag reading to track the evolution of contents in a container throughout a user or customer's progression through a store or retail environment, based on distinguishing between the RFID tags of collected items and the RFID tags of on-shelf items and other background noise (e.g., including tracking the evolution of contents in a container at one or more periodic time intervals, tracking the contents in the container in continuous time, and/or tracking the changes in the contents in the container in continuous time, etc.).

Systems, apparatuses, processes (also referred to as methods), and computer-readable media (collectively referred to as “systems and techniques”) are described herein that can be used to perform selective reading and/or localization for individual RFID tags included in a plurality of RFID tags. For example, the systems and techniques can be used to localize multiple RFID tags within a container such as a shopping basket, cart, or other volume of interest, etc. In some cases, the systems and techniques can be configured to perform RFID tag localization to determine a two-dimensional (2D) location of each respective RFID tag. In some examples, the systems and techniques can be configured to perform RFID tag localization to determine a three-dimensional (3D) location of each respective RFID tag.

The systems and techniques can be used to implement an RFID system to perform 2D and/or 3D localization of respective RFID tags included in a plurality of RFID tags, based on using a plurality of different RFID reader devices positioned at corresponding, known locations within the environment nearby the RFID tags of interest. Each RFID reader device included in the plurality of RFID reader devices can be used to obtain respective RFID ranging measurements and/or RFID ranging estimates indicative of a distance from the particular RFID reader device to a respective RFID tag.

Each RFID tag can be localization in two or three dimensions based on using a location estimation engine to analyze the respective distance estimate or other RFID ranging information determined between the particular RFID tag and each respective RFID reader device included in the plurality of RFID reader devices at known locations or positions. For example, when five different RFID readers are positioned on or around a container or volume of interest (e.g., a basket, a shopping cart, a warehouse rack or shelf, a retail environment, a factor environment, etc.), each respective RFID reader can determine estimated RFID ranging information or estimated distances to each RFID tag of the plurality of RFID tags. Each RFID tag of the plurality of RFID tags can be associated with five different RFID range estimates. The different range estimates can each comprise a distance between the corresponding RFID reader device and the particular RFID tag. Each range estimate can additionally be associated with or to the known, configured location of the corresponding RFID reader device within the surrounding environment. In one illustrative example, the multiple RFID range estimates and corresponding locations of each RFID reader device making a respective RFID range estimate can be combined and analyzed to perform the 2D or 3D localization of the particular RFID tag.

In some examples, the systems and techniques can perform phase-based ranging (PBR) distance estimation to determine the distance between an RFID reader and an RFID tag. The RFID reader devices can each be configured to obtain a plurality of phase measurements (e.g., relative phase information, such as a phase change or phase difference) at a corresponding plurality of different carrier frequencies emitted by the RFID reader and backscattered by the RFID tag. The RFID reader devices can perform carrier frequency hopping according to a configured frequency hopping sequence, to transmit a pilot tone to the RFID tag on each one of the plurality of different carrier frequencies. The frequency hopping can be performed with separation of the different respective carrier frequencies in time (e.g., the RFID reader device can hop sequentially and/or successively through the plurality of carrier frequencies, with the RFID reader device configured to emit the pilot tone on only one carrier frequency of the configured plurality of carrier frequencies at any given point in time).

The frequency hopping to provide the pilot tone from each RFID reader device to the RFID tag can be performed within a single access between the RFID reader device and the RFID tag. For example, each RFID reader device can transmit the pilot tone according to a configured carrier frequency hopping sequence uniquely corresponding to the particular RFID reader device, where each RFID reader transmits the pilot tone as a single continuous carrier wave signal hopping between the respective carrier frequencies of the configured carrier frequency hopping sequence. Each RFID reader can receive from the RFID tag a corresponding plurality of modulated pilot tones comprising a reflection of the carrier tones transmitted on the plurality of carrier frequencies of the frequency hopping sequenced. The plurality of modulated pilot tones can be received as a single, continuous backscatter signal reflected by the RFID tag.

In one illustrative example, each RFID reader of a plurality of RFID readers used to perform the 2D or 3D PBR-based RFID tag localization can be configured to use a different (e.g., unique) carrier frequency hopping sequence. The plurality of RFID readers can be time synchronized with one another before performing the PBR-based RFID tag localization. The respective carrier frequency hopping sequences configured for the plurality of RFID readers can comprise a sequence of mutually exclusive (e.g., orthogonal) carrier frequencies to be used by the plurality of RFID readers to transmit a respective pilot tone, and no two RFID readers of the plurality of RFID readers are configured with the same carrier frequency at the same time (e.g., no carrier frequency of the plurality of carrier frequencies is used simultaneously by two or more RFID readers).

A first RFID reader of the plurality of RFID readers can be configured as a primary RFID reader for the group comprising the plurality of RFID readers. The first (e.g., primary) RFID reader can be used to start or initiate a Query command to the RFID tag of interest (e.g., the RFID tag being localized), causing the RFID tag to reply to the Query by initially backscattering a pilot tone using the first carrier frequency from the frequency hopping sequence for the primary RFID reader. Based on the remaining, non-primary RFID readers being synchronized with the primary RFID reader, each remaining non-primary RFID reader can also start transmitting a carrier according to the respective frequency hopping sequence configured for each non-primary RFID reader. The RFID tag can receive the carrier from each RFID reader, on a different carrier frequency for each RFID reader. Modulation of the carrier from the primary RFID reader causes the RFID tag to also modulate and backscatter the carriers on the different frequencies transmitted at the same time by each remaining non-primary RFID reader. The synchronized RFID readers can sequentially hop through their respective carrier frequency hopping sequences, with each RFID reader using a different frequency from the other RFID readers at all times. The RFID readers can utilize the same carrier frequency hopping sequence, with each RFID reader configured to start from a different frequency within the same carrier frequency hopping sequence.

In some examples, one or more fixed reference tags can be used to improve the accuracy of the RFID distance estimation or ranging, and/or item inventory estimation for the contents of the container. For example, a fixed reference tag can be implemented as an RFID tag attached to a known location on or within the container (e.g., the shopper's basket or other volume of interest for selective RFID tag reading). In one illustrative example, a plurality of RFID tags can be used as fixed references for a calibration process performed by the RFID reader before the RFID ranging-based item inventory estimation of the contents in the container. For example, a respective fixed reference RFID tag can be attached to one or more (or all) of the four bottom interior corners and/or four top interior of a container (e.g., a shopper's basket). Calibration can be performed based on placing the RFID reader device (e.g., a smartphone, UE, or other mobile computing device associated with the user) within the container, and performing a respective RFID ranging measurement between the RFID reader and each one of the fixed reference RFID tags. For example, the RFID reader can perform calibration based on a respective RFID ranging measurement with one or more (or all) of a front bottom left reference RFID tag, a front bottom right reference RFID tag, a back bottom left reference RFID tag, a back bottom right reference RFID tag, a front upper left reference RFID tag, a front upper right reference RFID tag, a back upper left reference RFID tag, and/or a back upper right reference RFID tag, etc. Based on the calibration RFID measurements from the RFID reader to the fixed reference RFID tags within the container volume, the RFID reader can determine its relative three-dimensional (3D) location within the container and/or relative to the known and fixed reference point locations for the respective RFID reference tags. From the relative 3D location of the RFID reader and/or the estimated distances from the RFID reader to the respective RFID reference tags, the systems and techniques can determine a calibration radius corresponding to the container volume, where RFID tags with an estimated distance greater than the calibration radius are identified as not included in the container content item inventory, and where RFID tags with an estimated distance less than or equal to the calibration radius are identified as included in the container content item inventory.

Further aspects of the systems and techniques will be described with reference to the figures.

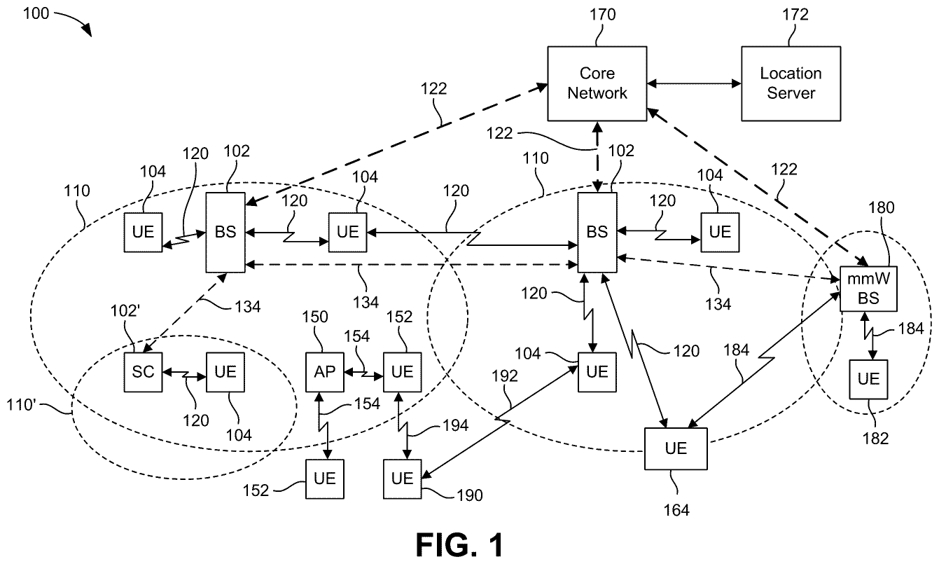

According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

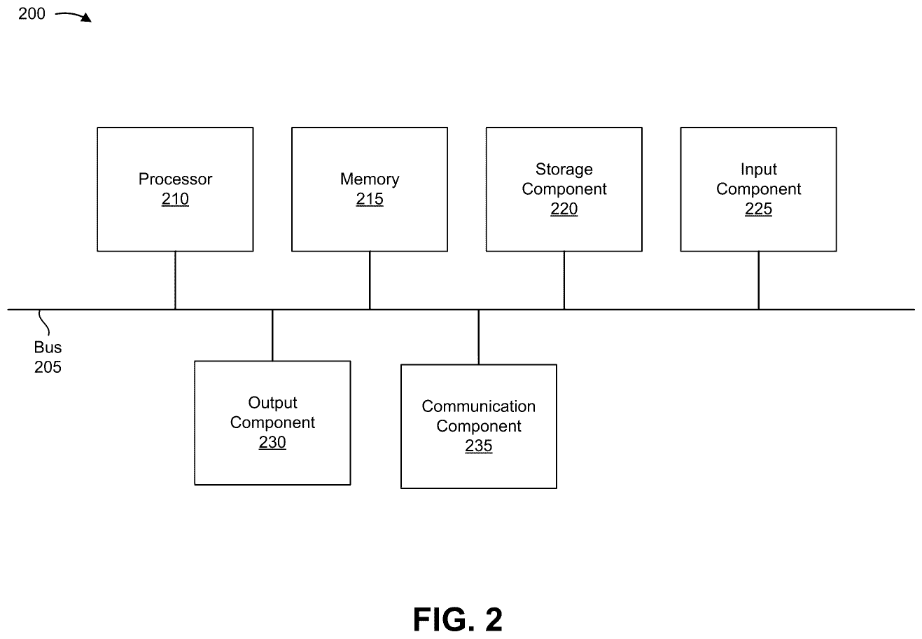

FIG. 2 is a diagram illustrating example components of a device 200, in accordance with the present disclosure. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

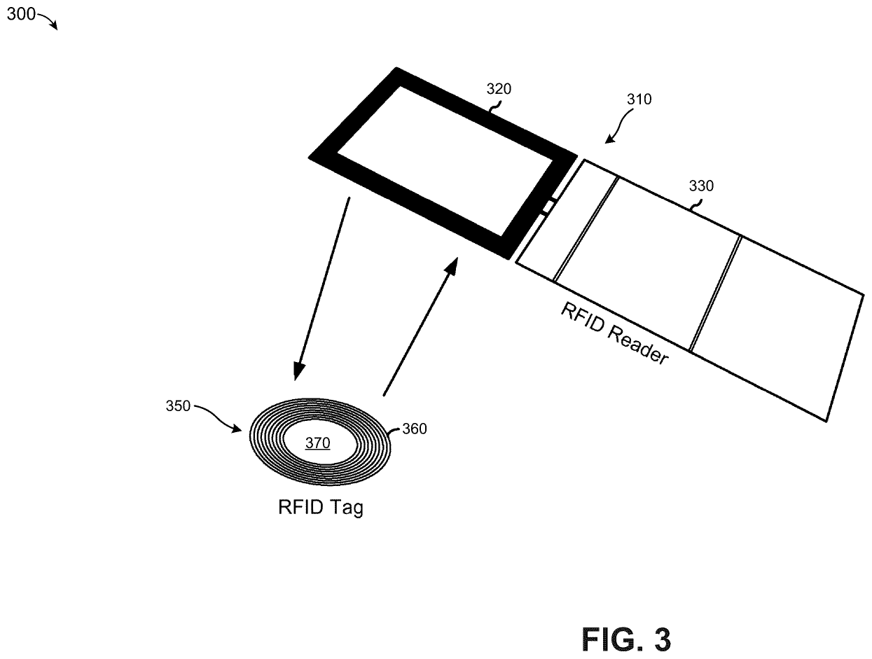

FIG. 3 is a diagram illustrating an example RFID system 300 that includes an RFID reader (e.g., energizer) 310 and an RFID tag 350. RFID reader 310 may also be referred to as an interrogator, a scanner, an energizer, etc. RFID tag 350 may also be referred to as an RFID label, an electronics label, etc.

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via its antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries. The specified maximum transmit power level of RFID reader 310 limits the distance at which RFID tag 350 can be read by RFID reader 310.

As noted previously, the systems and techniques described herein can be used to perform RFID tag localization based on using a plurality of RFID reader devices with mutually exclusive (e.g., orthogonal) and synchronized carrier frequency hopping sequences that can be used by each RFID reader device to obtain a respective set of PBR or other phase measurement information at a plurality of carrier frequencies. The synchronized RFID readers can obtain a plurality of phase change or other phase measurements that can be used to determine a respective distance between the RFID tag and each RFID reader, for example using phase-based ranging techniques (e.g., PBR-based distance estimation, etc.). The respective distance from the RFID tag to each RFID reader can be analyzed and used to perform 2D or 3D localization of the RFID, and/or can be used to perform selective reading of RFID tags and RFID tag identification information corresponding to collected items of a container, such as a shopper's basket (e.g., also referred to as “basket contents”). The systems and techniques can perform PBR-based RFID tag localization using the synchronized carrier frequency hopping (e.g., channel hopping) sequences and/or can be used to perform selective RFID tag reading to determine, generate, and/or update item inventory information corresponding to the selectively read RFID tags. In one illustrative example, the item inventory information of selectively read RFID tags can correspond to RFID tagged items that are within the container (e.g., the shopper's basket).

In some aspects, an RFID reader can perform channel hopping to switch between a plurality of different carrier frequencies during the transmission of a tone signal to the RFID tag. The RFID tag can backscatter a modulated tone signal at each respective carrier frequency of the plurality of different carrier frequencies during the transmission from the RFID reader, and the RFID reader can determine a respective phase measurement (e.g., phase change measurement) and/or can determine relative phase information for each carrier frequency of the plurality of different carrier frequencies.

In some aspects, RFID communications can be performed between an RFID reader and one or more RFID tags of a plurality of RFID tags (e.g., RFID tags attached to corresponding items, also referred to as “RFID tagged items”). The RFID communications may include one or more RFID measurements such as phase-based ranging (PBR) measurements, Received Signal Strength Indicator (RSSI) measurements, and/or various combinations thereof. PBR measurements can be performed between an RFID reader device and an RFID tag, where the RFID reader device is configured to transmit an energizing or interrogating signal and the RFID tag is configured to reflect the interrogating signal as a backscatter signal (e.g., also referred to as a “reflected signal” and/or “reply signal”).

For illustrative purposes, examples are described herein using a shopper's “basket” as an illustrative example of a container. However, the systems and techniques also apply to any other type of container. A shopper's “basket” (or container) can refer to any receptacle or volume within which items are placed for temporary storage and/or transport (e.g., prior to purchase or other use). For example, a shopper's “basket” can include various implementations, such as a handheld-basket, a cart or trolley, a bag or satchel, etc. A shopper's “basket” or “basket contents” may also refer to the hand carry of one or more items by a shopper.

In some aspects, RFID measurements can be performed with a plurality of RFID tags (e.g., RFID tags attached to corresponding items, also referred to as “RFID tagged items”). The RFID measurements can include phase-based ranging (PBR) measurements, Received Signal Strength Indicator (RSSI) measurements, and/or various combinations thereof. PBR measurements can be performed between an RFID reader device and an RFID tag, where the RFID reader device is configured to transmit an energizing or interrogating signal and the RFID tag is configured to reflect the interrogating signal as a backscatter signal (e.g., also referred to as a “reflected signal” and/or “reply signal”).

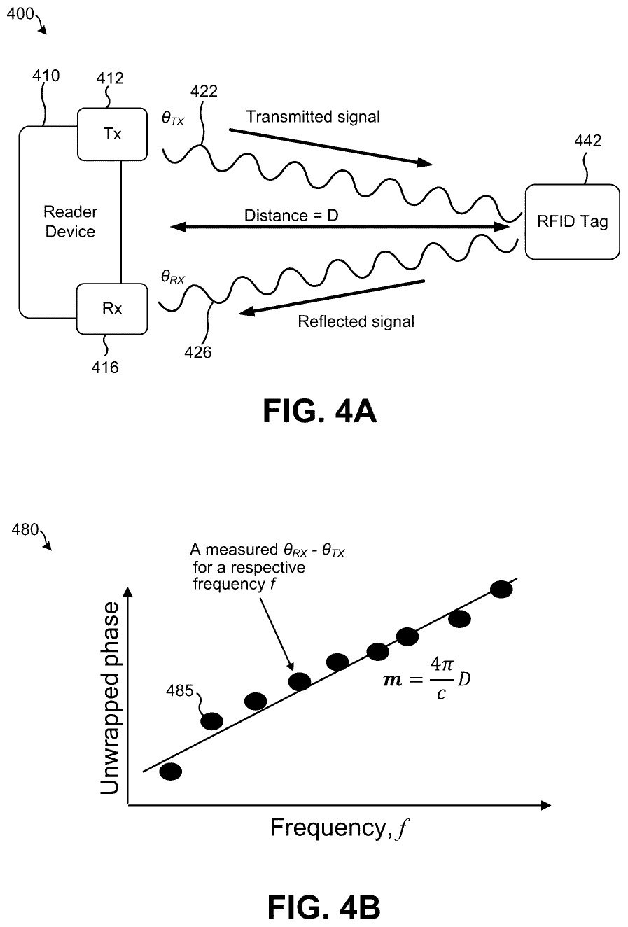

For example, FIG. 4A is a diagram illustrating an example of an RFID system 400 that can be used for phase-based ranging (PBR) and/or PBR-based distance estimation, in accordance with some examples. An RFID reader device 410 can include a transmitter (Tx) 412 and a receiver (Rx) 416, configured to transmit and receive RF signals, respectively. The RFID reader device 410 can use the transmitter 412 to transmit a transmitted signal 422 to an RFID tag 442. The transmitted signal 422 may be associated with a transmitted phase Orx. In some cases, the transmitted signal 422 may be a modulated signal, or may be an unmodulated signal (e.g., a carrier signal).

The transmitted signal 422, with phase θ_{TX}, propagates a distance D between the reader device 410 and the RFID tag 442, where the distance D is the separation distance or range between the reader device 410 and the RFID tag 442 (e.g., and where the distance D is relatively small such that propagation time does not have a significant effect on the measurement(s)). The RFID tag 442 can be a backscatter RFID tag configured to backscatter (e.g., reflect) an incident signal. For example, the RFID tag 442 can backscatter (e.g., reflect) the transmitted signal 422 as a reflected signal 426. The reflected signal can be associated with a phase θ_{TX} that may be different from the transmitted phase θ_{TX}. The reflected signal 426 is transmitted back to the RFID reader device 410, and is received by the receiver 416 of the RFID reader device 410, with the phase θ_{TX}. In some examples, the reflected signal 426 is weaker (e.g., lower power) than the transmitted signal 422. In some examples, the reader device 410 may generate the transmitted signal as a 900 megahertz (MHz) signal with phase θ_{TX}, among various other frequencies.

In one illustrative example, the RFID reader device 410 can perform phase-based ranging (PBR) measurements based on determining a phase difference between the transmitted signal 422 and the reflected signal 426. For example, a PBR measurement can correspond to the phase difference θ_{RX}-θ_{TX} between the transmitted signal 422 and reflected signal 426 (respectively) at the RFID reader device 410. In some aspects, the RFID reader device 410 determines the phase difference θ_{TX}-θ_{TX} based on removing the relatively strong transmitted signal 422 from the relatively weak reflected signal 426, which may introduce a source of phase error to both the phase difference measurement and the PBR measurement.

In some aspects, the carrier phase may change based on propagation distance at carrier frequency f_{c}, and distance D can be determined as:

$$D ≅ \frac{1}{2} \cdot \frac{{θ}_{R X} - {θ}_{T X}}{2 π} \cdot \frac{c}{{f}_{c}} \qquad Eq . ( 1 )$$

In some examples, a fixed calibration can be performed to account for antennas and reflection in the particular RFID tag 442. In some cases, the maximum range value that can be accurately and/or reliably determined using Eq. (1) can be based on the carrier frequency f_{c}. For example, the frequency f_{c} and the wavelength/may vary inversely with one another, and PBR performed according to Eq. (1) may be associated with a maximum range (e.g., a maximum value of D) of λ/2, etc.

In some cases, a plurality of PBR measurements can be performed between the RFID reader device 410 and each RFID tag 442 that is of interest or within range of the transmitted signal 422. In one illustrative example, a plurality of transmitted signals 422 can be generated and transmitted by the RFID reader device 410, where each transmitted signal uses a different frequency. A phase difference measurement can be determined for each pair of transmitted signals at a particular frequency and the corresponding reflected signal.

For example, FIG. 4B is a diagram illustrating a plot 480 of PBR-based distance estimation using a plurality of RFID phase measurements 485, in accordance with some examples. For example, each RFID phase measurement 485 can be a phase difference measurement, such as the phase difference measurement θ_{RX}-θ_{TX} between the transmitted signal 422 and reflected signal 426 of FIG. 4A for a particular frequency f_{c}.

In some aspects, each RFID phase measurement 485 can be a phase difference (e.g., relative phase information, etc.) measured between a transmitted signal at a respective carrier frequency f_{c}, and a corresponding reflected signal (e.g., a reflection or backscatter modulation of the transmitted signal, by an RFID tag). Each RFID phase measurement 485 of the plurality of RFID phase measurements 485 of FIG. 4B can correspond to signals between an RFID reader and particular RFID tag, such as the RFID reader device 410 and RFID tag 442 of FIG. 4A. In some cases, each phase difference 485 can be determined for a transmitted signal (e.g., RF carrier transmitted by the RFID reader) having a carrier frequency f_{c} that is a configured offset fₛ away from the adjacent phase difference measurements 485 made at (f_{c}+fₛ) and (f_{c}−fₛ).

In one illustrative example, PBR measurements can be performed to obtain the plurality of phase differences 485 using a plurality of different transmitted signal carrier frequencies f_{c} for the transmitted signal 422 from the RFID reader device 410 of FIG. 4A. A PBR-based distance estimate can be determined based on the gradient (e.g., slope) of a best-fit line determined for the plurality of phase difference measurements 485. For example, the gradient m can be determined as:

$$m = \frac{- 4 π}{c} D \qquad Eq . ( 2 )$$

Here, D represents the PBR-based distance estimate between the RFID reader device 410 and the RFID tag 442. The term c represents the speed of light (e.g., which is the speed with which the RF signals travel or propagate between the RFID reader and RFID tag).

In some examples, a variance of the estimated distance D can be determined as σ_{D}², where σ_{D}² is based on the gradient-error equation of the best-fit line for the gradient m, the phase noise variance σ_{ϵ}², the frequency spacing fₛ, and the number of uniformly-spaced samples N in the plurality of phase difference measurements 485:

$${σ}_{D}^{2} = \frac{3 {σ}_{ϵ}^{2} {c}^{2}}{4 {π}^{2} {f}_{s}^{2} ( {N}^{3} - N )} \qquad Eq . ( 3 )$$

The term σ_{ϵ} represents the total phase noise, which can comprise principal components:

$${σ}_{ϵ}^{2} = {σ}_{ϵ G}^{2} + {σ}_{ϵ V}^{2} .$$

For example,

$${σ}_{ϵ V}^{2}$$

can represent the phase noise variance due to the VCO oscillator, and may be a function of the reader radio (e.g., the RFID reader device 410 radio, such as Rx 416 and/or Tx 412) and any additional phase noise introduced by the tag (e.g., the RFID tag 442) and the signal cancellation.

The term

$${σ}_{ϵ G}^{2}$$

can represent the phase noise variance based on Gaussian noise. For example, for SNR_{dB} 10>dB, the Gaussian noise (e.g., SNR) can create an approximate phase noise σ_{ϵG} according to:

$${σ}_{ϵ G} ≅ \sqrt{\frac{1}{2 \cdot SNR}} , where SNR = {10}^{\frac{S N {R}_{d B}}{10}} \qquad Eq . ( 4 )$$

In some aspects, based on averaging multiple samples N (e.g., multiple phase difference measurements, such as the plurality of phase difference measurements 485 of FIG. 4B), the Gaussian phase noise dec of Eq. (4) can be reduced. Reducing the Gaussian phase noise σ_{ϵG} can reduce the variance of the PBR-based distance estimate D, with the variance given according to Eq. (3).

For example, in some aspects, PBR distance estimation can be performed based on analyzing the phase change in an RF carrier, where the phase change in the RF carrier is based on the distance between two radio antennas. The phase change of the RF carrier can be analyzed to measure and/or determine range. In one illustrative example, multiple phase measurements (e.g., phase difference measurements 485 of FIG. 4B) can be obtained, each at different respective carrier frequencies f_{c}.

The gradient, m, of a best-fit line through the unwrapped phases, against carrier frequency f_{c}, can be used as a good approximation to the distance D between the radios (e.g., between the RFID reader device 410 and the RFID tag 442 of FIG. 4A). For example, in the context of RFID, PBR distance estimation can be used to determine the distance (e.g., range) between an RFID reader device and a particular RFID tag. A single phase change can be measured by the RFID reader device, for example on a single carrier, by transmitting an RF carrier, with the RFID tag configured to backscatter the carrier modulated with a modulated tone (e.g., 1010101010, etc.). For instance, transmitting an RF carrier can correspond to the transmitted signal 422 transmitted by the RFID reader device 410 of FIG. 4A. The RFID tag backscattering the carrier modulated with a modulated tone can correspond to the reflected signal 426 from the RFID tag 442 of FIG. 4A.

For example, in RFID RAIN (e.g., Radio Frequency Identification Recognize, Action, Interact, Network), the transmitted signal 422 and reflected signal 426 can be implemented based on an RFID tag (e.g., the RFID tag 442 of FIG. 4A) responding to a Query command (e.g., transmitted by the RFID reader device 410 of FIG. 4A). In some aspects, the RFID reader device 410 (e.g., and Rx 416 thereof) can measure a single phase-difference from the modulated tone signal on either side of the DC carrier, to obtain an individual phase difference 485 for a corresponding carrier frequency f_{c}.

The distance estimate D can be determined based on multiple phase difference measurements 485, as noted above. In some cases, multiple commands can be transmitted from the RFID reader device 410 to the RFID tag 442 (e.g., multiple Query transmissions). In some cases, a separate Query command (e.g., a separate transmitted signal 422) can be used for each phase difference measurement 485 at a corresponding carrier frequency f_{c}. In some aspects, the RFID reader device 410 can be configured to change the carrier frequency f_{c} of the transmitted signal 422 during the reading back of the modulated tone of the reflected signal 426 from the RFID tag 442. For instance, in examples where the RFID tag 442 is a passive RFID tag, the RFID tag 442 is not aware of the change in carrier frequency f_{c} and will continue to reflect the modulated tone with the newly adjusted RF carrier.

In one illustrative example, the RFID reader device 410 can be configured to capture the reflected signal 426 from the RFID tag 442 that is responsive to the changing carrier frequency and/or RF carrier used for the transmitted signal 422. Based on storing information indicative of the respective time(s) when the RFID reader device 410 changed the carrier frequency for the transmitted signal 422, the RFID reader device 410 can be configured to extract or determine the relative phase difference information 485 for each frequency of interest associated with plotting the plurality of measurements 485 along the horizontal frequency axis of the plot 480 of FIG. 4B. In some aspects, the distance estimate D can be determined using a single message (e.g., transmitted signal 422, Query message with changing RF carrier, etc.) from the RFID reader device 410 to the RFID tag 442.

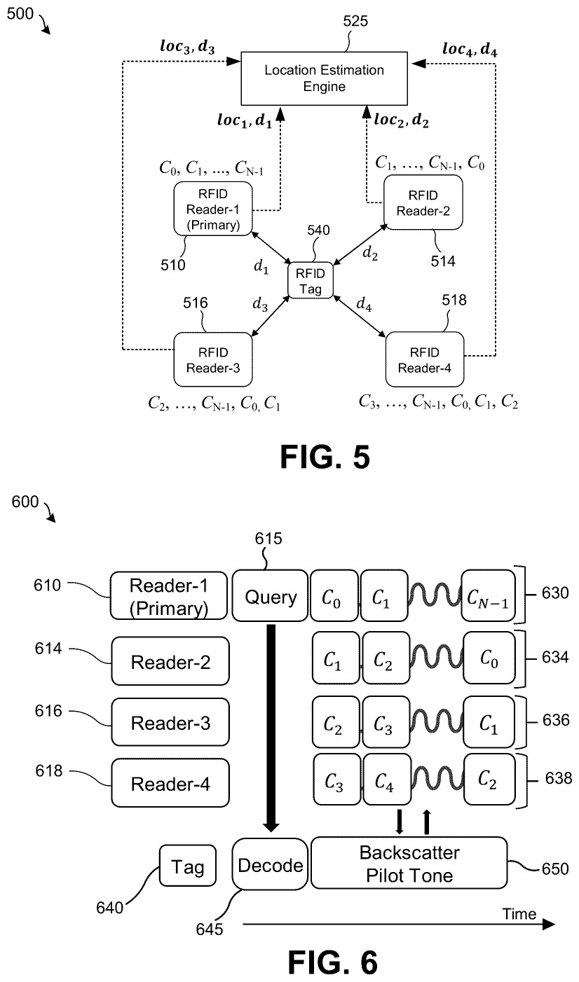

FIG. 5 is a diagram illustrating an example of an RFID system 500 that can be used to perform RFID tag localization using synchronized phase-based ranging with respective carrier frequency hopping sequences implemented by a plurality of RFID reader devices, in accordance with some examples. For example, the RFID system 500 can include a plurality of RFID reader devices comprising the group of RFID readers RFID reader-1 510, RFID reader-2 514, RFID reader-3 516, and RFID reader-4 518, etc. The RFID readers 510, 514, 516, 518 may be the same as or similar to one another, and/or may be different from one another.

Each RFID reader 510, 514, 516, 518 may be the same as or similar to one or more of the RFID reader 310 of FIG. 3, the RFID reader 410 of FIG. 4A, etc. Each RFID reader of the plurality of RFID readers included in the RFID system 500 of FIG. 5 can be configured to perform phased-based ranging to determine a corresponding distance dn between itself and an RFID tag 540. The RFID tag 540 can be the same as or similar to one or more of the RFID tag 350 of FIG. 3, 440 of FIG. 4A, etc. The RFID tag 540 can be one RFID tag included in a plurality of RFID tags within communication range of the RFID readers of the RFID system 500 (e.g., can be included in a plurality of RFID tags within the surrounding environment of the RFID readers 510, 514, 516, 518 and/or the RFID system 500, etc.).

In some aspects, the first RFID reader-1 510 can perform PBR measurements to determine the distance d₁ between the RFID tag 540 and the first RFID reader-1 510. The first RFID reader-1 510 can use a corresponding carrier frequency hopping sequence (e.g., channel hopping sequence) C₀, C₁, . . . , C_{N-1} to obtain N relative phase measurements from the RFID tag 540 backscattering the carrier signal (e.g., pilot tone) transmitted by the first RFID reader-1 510 on the N different carrier frequencies C₀, C₁, . . . , C_{N-1}.

The second RFID reader-2 514 can perform PBR measurements to determine the distance d₂ between the RFID tag 540 and the second RFID reader-2 514. The second RFID reader-2 514 can use a corresponding carrier frequency hopping sequence (e.g., channel hopping sequence) C₁, C₂, . . . , C_{N-1}, C₀ to obtain N relative phase measurements from the RFID tag 540 backscattering the carrier signal (e.g., pilot tone) transmitted by the second RFID reader-2 514 on the N different carrier frequencies. In some aspects, RFID reader-1 510 and RFID reader-2 514 use the same set of N different carrier frequencies, arranged in a different order (e.g., different frequency sequence).

The third RFID reader-3 516 can perform PBR measurements to determine the distance d₃ between the RFID tag 540 and the third RFID reader-3 516. The third RFID reader-3 516 can use a corresponding carrier frequency hopping sequence (e.g., channel hopping sequence) C₂, C₃, . . . , C_{N-1}, C₀, C₁ to obtain N relative phase measurements from the RFID tag 540 backscattering the carrier signal (e.g., pilot tone) transmitted by the third RFID reader-3 516 on the N different carrier frequencies. In some aspects, RFID reader-1 510, RFID reader-2 514, and RFID reader-3 516 can use the same set of N different carrier frequencies, arranged in a different order (e.g., different frequency sequence).

The fourth RFID reader-4 518 can perform PBR measurements to determine the distance d₄ between the RFID tag 540 and the fourth RFID reader-4 518. The fourth RFID reader-4 518 can use a corresponding carrier frequency hopping sequence (e.g., channel hopping sequence) C₃, C₄, . . . , C_{N-1}, C₀, C₁, C₂ to obtain N relative phase measurements from the RFID tag 540 backscattering the carrier signal (e.g., pilot tone) transmitted by the fourth RFID reader-4 518 on the N different carrier frequencies. In some aspects, RFID reader-1 510, RFID reader-2 514, RFID reader-3 516, and RFID reader-4 518 can use the same set of N different carrier frequencies, arranged in a different order (e.g., different frequency sequence).

In some aspects, the RFID readers 510, 514, 516, and 518 included in the RFID system 500 can be synchronized with one another (e.g., the RFID readers 510, 514, 516, and 518 can communicate with one another to establish a synchronized internal clock for timing the frequency hops of the respective frequency sequence configured for each RFID reader). Each RFID reader can be configured with a pre-determined frequency sequence for performing the hops between the N different carrier frequencies associated with obtaining the phase measurement information from the RFID tag 540 used for the subsequent PBR-based distance estimation performed by each RFID reader.

As noted above, each RFID reader 510, 514, 516, and 518 can be configured with a pre-determined frequency sequence that utilizes the same set of N different carrier frequencies, arranged in a different order for each RFID reader such that each RFID reader 510, 514, 516, 518 implements a sequence of mutually exclusive (e.g., orthogonal) carrier frequencies for obtaining the phase change measurements for the PBR-based distance estimation process for the RFID tag 540.

For example, FIG. 6 is a diagram illustrating another example of an RFID system 600 that can be used to perform RFID tag localization using synchronized phase-based ranging with respective carrier frequency hopping sequences implemented by a plurality of RFID reader devices, in accordance with some examples. The reader-1 610 can be the same as or similar to the reader-1 510 of FIG. 5, the reader-2 614 can be the same as or similar to the reader-2 514 of FIG. 5, the reader-3 616 can be the same as or similar to the reader-3 516 of FIG. 5, and the reader-4 618 can be the same as or similar to the reader-4 518 of FIG. 5. The RFID tag 640 can be the same as or similar to the RFID tag 540 of FIG. 5.

One RFID reader included in the plurality of RFID readers of the RFID system can be selected and/or configured as a primary RFID reader for performing the synchronized PBR-based distance estimation to the RFID tag, with the remaining RFID readers of the RFID system configured as non-primary RFID readers. For example, in the RFID system 500 of FIG. 5, the first RFID reader-1 510 can be configured as the primary RFID reader for the synchronized PBR-based distance estimation and/or localization for the RFID tag 540. The remaining RFID readers of the RFID system 500 (e.g., RFID reader-2 514, RFID reader-3 516, and RFID reader-4 518) can each be configured as non-primary RFID readers that synchronize with and based on the primary RFID reader-1 510.

In the RFID system 600 of FIG. 6, the first RFID reader-1 610 can be configured as the primary RFID reader for the synchronized PBR-based distance estimation and/or localization for the RFID tag 640. The remaining RFID readers of the RFID system 600 (e.g., RFID reader-2 614, RFID reader-3 616, and RFID reader-4 618) can each be configured as non-primary RFID readers that synchronize with and based on the primary RFID reader-1 610.

The primary RFID reader can be used to start and/or transmit a Query command to a selected RFID tag for the synchronized PBR-based distance estimation and localization process. For example, primary RFID reader-1 510 of FIG. 5 can start and/or transmit a Query command to the RFID tag 540 and/or the remaining, non-primary RFID readers 514, 516, and 518 to initiate the synchronized frequency hopping and phase measurements for the RFID tag 540. The primary RFID reader-1 610 of FIG. 6 can start and/or transmit a Query command 615 to the RFID tag 640 to initiate the syn chromized frequency hopping and phase measurements for the RFID tag 640. In some aspects, the remaining, non-primary RFID readers 614, 616, and 618 may also receive the Query command 615 transmitted by the primary RFID reader 610.

Transmission of the Query command 615 by the configured primary RFID reader 610 can cause the RFID tag 640 to reply to the Query command 615 by initially backscattering a pilot tone using the RF carrier from the primary RFID reader 610. For example, the RFID tag 640 can decode 645 the Query command 615 and begin transmitting (e.g., reflecting) a backscatter pilot tone 650 based on and/or using the RF carrier from the primary RFID reader 610. The RFID tag 640 can subsequently complete the transmission of the tag-to-reader message preamble symbols, and the symbols corresponding to the rest of the Query response provided by the backscatter pilot tone 650 modulated and reflected by the RFID tag 640.

In one illustrative example, based on the synchronization of the non-primary RFID readers 614, 616, and 618 with the configured primary RFID reader 610, the transmission of the Query command 615 by the primary RFID reader 610 can additionally cause each one of the remaining, non-primary RFID readers 614, 616, and 618 to start transmitting a respective RF carrier immediately following the end of the Query command 615. Based on the time (e.g., internal clock) synchronization between all of the RFID readers (e.g., primary 610 and non-primary 614, 616, and 618) of the RFID system 600, each RFID reader 610, 614, 616, and 618 can begin transmitting the first RFID carrier frequency from the corresponding mutually exclusive (e.g., orthogonal) carrier frequency sequence configured for each RFID reader.

For example, the primary RFID reader 610 is configured with the carrier frequency sequence 630 (with a first carrier frequency of C₀), which may be the same as the carrier frequency sequence configured for the primary RFID reader 510 of FIG. 5. The non-primary RFID reader 614 is configured with the carrier frequency sequence 634 (with a first carrier frequency of C₁), which may be the same as the carrier frequency sequence configured for the non-primary RFID reader 514 of FIG. 5. The non-primary RFID reader 616 is configured with the carrier frequency sequence 636 (with a first carrier frequency of C₂), which may be the same as the carrier frequency sequence configured for the non-primary RFID reader 516 of FIG. 5. The non-primary RFID reader 618 is configured with the carrier frequency sequence 638 (with a first carrier frequency of C₃), which may be the same as the carrier frequency sequence configured for the non-primary RFID reader 518 of FIG. 5.

Based on the synchronization of the primary RFID reader 610 and the non-primary RFID readers 614, 616, and 618, each RFID reader begins transmitting a pilot tone using the respective first carrier frequency of the RFID reader's unique (e.g., mutually exclusive (e.g., orthogonal)) carrier frequency sequence at the same time. For example, RFID readers 610, 614, 616, and 618 begin transmitting the first carrier frequency of their respective configured carrier frequency sequences 630, 634, 636, and 638 (respectively) at the same synchronized start time, and finish transmission of the first carrier frequency of their respective configured carrier frequency sequences at the same synchronized end time. The RFID readers 610, 614, 616, and 618 can similarly begin transmitting the second carrier frequency of their frequency sequences 630, 634, 636, and 638 (respectively) at the same time, can begin transmitting the third carrier frequency of their frequency sequences at the same time, . . . , etc.

Based on the RFID tag 640 being already committed to modulating the primary RFID reader 610's carrier with a pilot signal (e.g., based on the RFID tag 640 receiving and decoding 645 the earlier Query command 615 transmitted by the primary RFID reader 610), when the remaining non-primary carriers are enabled or started by the remaining non-primary RFID readers 614, 616, and 618, the modulation at the RFID tag 640 will cause backscattering on each non-primary carrier as well. For example, the RFID readers 610, 614, 616, and 618 can synchronously start their respective first carrier frequencies C₀, C₁, C₂, and ('s at the same starting time, and the RFID tag 640 can modulate and backscatter the pilot tone received from each RFID reader 610, 614, 616, and 618 on the carrier frequencies C₀, C₁, C₂, and C₃ (respectively).

Each RFID reader can be configured to hop through its configured carrier frequency sequence (e.g., channel sequence) 630, 634, 636, 638 while maintaining synchronization between the starting time and ending time for each different carrier frequency of the respective sequence. In one illustrative example, the RFID readers 610, 614, 616, and 618 hop synchronously through their respective carrier frequency (e.g., channel) sequences 630, 634, 636, 638 (respectively) in sequential order over the period of the single pilot tone transmission. The period of the single pilot tone transmission from each RFID reader can be the same, and may be equal to the period (e.g., time duration, length, etc.) of the backscatter pilot tone 650 shown as being reflected by the RFID tag 640 of FIG. 6. In some aspects, each RFID reader can hop sequentially through its configured carrier frequency sequence 630, 634, 636, 638 in sequential order over the period of the pilot tone, based on the RFID system 600 implementing control of the phase locked loop (PLL) to avoid phase unlock of the RFID readers 610, 614, 616, 618. In some cases, additional time can be configured (e.g., between sequential carrier frequencies of the respective frequency sequences 630, 634, 636, 638) to provide enough time for each RFID reader 610, 614, 616, 618 to perform a proper channel change between the sequential carrier frequency pairs of the configured frequency sequence.

At the end of the pilot tone period (e.g., the end of the backscatter pilot tone 650 shown in FIG. 6), each RFID reader 610, 614, 616, and 618 will have obtained phase measurement information or relative phase information from the backscattered pilot tone 650 reflected by the RFID tag 640 over multiple different carrier frequencies (e.g., over the N different carrier frequencies used for each of the mutually exclusive (e.g., orthogonal) frequency sequences 630, 634, 636, 638).

Each RFID reader knows when it changed carrier frequencies (e.g., performed a frequency hop synchronously with the other RFID readers included in the RFID system 600), and can therefore determine or extract the relative phase information from the backscatter pilot tone 650 received by each RFID reader 610, 614, 616, 618 from the RFID tag 640. In some aspects, the extracted relative phase information can be phase change information corresponding to each carrier frequency of the RFID reader's corresponding frequency sequence 630, 634, 636, 638.

The extracted relative phase information determined by each RFID reader 610, 614, 616, 618 can subsequently be used to determine the distance from the RFID reader to the RFID tag 640, for example using PBR-based ranging techniques (e.g., estimating the distance as the gradient of the best fit line between the set of phase measurement points determined by each respective RFID reader 610, 614, 616, 618, as in the example of FIG. 4B, etc.).

For example, the primary RFID reader 510 of FIGS. 5 and/or 610 of FIG. 6 can determine a PBR-based ranging estimate of the distance d₁ from the location loc of the primary RFID reader 510, 610 to the RFID tag 540, 640. The non-primary RFID reader 514 of FIGS. 5 and/or 614 of FIG. 6 can determine a PBR-based ranging estimate of the distance d₂ from the location loc₂ of the non-primary RFID reader 514, 614 to the RFID tag 540, 640. The non-primary RFID reader 516 of FIGS. 5 and/or 616 of FIG. 6 can determine a PBR-based ranging estimate of the distance d; from the location loc₃ of the non-primary RFID reader 516, 616 to the RFID tag 540, 640. The non-primary RFID reader 518 of FIGS. 5 and/or 618 of FIG. 6 can determine a PBR-based ranging estimate of the distance d₄ from the location loca of the non-primary RFID reader 518, 618 to the RFID tag 540, 640.

In some aspects, by synchronizing the RFID readers of the RFID system 500 of FIG. 5 and/or the RFID system 600 of FIG. 6, the systems and techniques described herein can be configured to apply carrier parallelism to determine a complete 2D or 3D location estimate of the RFID tag 540 or 640 (respectively). The systems and techniques can, in some aspects, utilize a location estimation engine 525 that is separate from the RFID readers (e.g., RFID readers 510, 514, 516, 518 of FIG. 5) to combine or otherwise perform a joint analysis of the respective PBR ranging distance estimate determined to the RFID tag 540 from the respective known location locᵢ-loc₄ for each of the RFID readers 510, 514, 516, 518 included in the RFID system 500. For example, the location estimation engine 525 can apply the carrier parallelism and perform triangulation and/or localization of the RFID tag 540, in 2D or 3D, using the respective PBR range estimate determined by each RFID reader 510, 514, 516, 518. In one illustrative example, the 2D or 3D localization of the RFID tag 540 can be determined significantly faster than existing localization techniques, which must access each RFID tag multiple times to obtain the multiple measurements at the plurality of frequencies within the desired frequency band or frequency range. For example, the systems and techniques can perform the 2D or 3D localization of the RFID tag 540 based on data obtained from a single pilot tone, where the single pilot tone phase measurement data is indicative of the phase change at each frequency of the plurality of carrier frequencies N used for each carrier frequency sequence configured for the different RFID readers.

Based on the time synchronization between the primary RFID reader and the remaining, non-primary RFID readers of the RFID system, all RFID readers change their carrier transmit frequencies simultaneously, and during the period of the same single pilot tone used for the PBR-based ranging. Each RFID reader captures the corresponding backscattered response(s) from the RFID tag (e.g., the backscatter pilot tone 650 reflected by the RFID tag 640 for each carrier frequency sequence 630, 634, 636, 638 of FIG. 6), in the specific frequency band(s) configured in the corresponding sequence for each RFID reader. Because the frequency sequences used by each RFID reader are mutually exclusive (e.g., orthogonal), the RFID readers make simultaneous phase change or relative phase measurements at different parts of the frequency. The simultaneous phase measurements at different frequencies can be used by the location estimation engine 525 of FIG. 5 to mitigate multipath effects, and can be used to determine unambiguous distance estimates and/or 2D or 3D localization information for the RFID tag (e.g., 540, 640, etc.) from phase measurements.

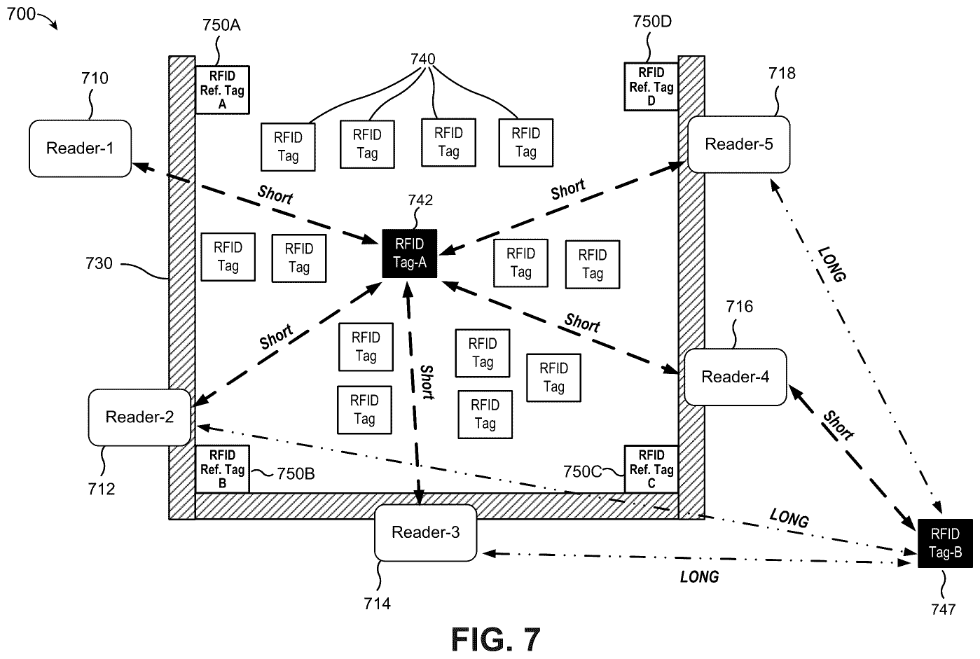

FIG. 7 is a diagram illustrating an example of an RFID system 700 for determining container contents or RFID item inventory information using a plurality of RFID readers with respective synchronized carrier frequency hopping sequences for PBR-based distance estimation and item localization, in accordance with some examples.

For example, the RFID system 700 can include a plurality of RFID readers 710, 712, 714, 716, 718 that are attached to or associated with a container 730 (e.g., a shopping basket, shopping cart, volume of interest within which RFID-tagged items are placed, etc.). The RFID readers 710-718 can be the same as or similar to one or more of the RFID readers of FIGS. 3-6. In some aspects, the RFID system 700 and the RFID readers 710-718 can be used to perform selective RFID tag reading and/or container contents item inventor estimation. A plurality of RFID tags 740, including a currently read RFID tag-A 742, can be located within the container volume of interest 730, and should be included in the item inventory information determined by the selective reading of the RFID tags of the contents of the container 730. One or more RFID tags, including an RFID tag-B 747, can be located outside of the container volume of interest 730, and should not be included in the item inventor information determined by the selective reading of the RFID tags of the contents of the container 730.

In some examples, one or more fixed reference RFID tags 750A, 750B, 750C, and 750D, etc., can be used to improve the accuracy of the RFID distance estimation or ranging and/or the basket 730 content item inventory estimation performed by the RFID system 700 of FIG. 7. For example, a fixed reference tag can be implemented as an RFID tag attached to a known location on or within the shopper's basket (or other volume of interest for selective RFID tag reading). In one illustrative example, a plurality of RFID tags can be used as fixed references for a calibration process performed by the RFID readers 710-718 before the frequency hopping PBR-based RFID ranging and localization process is performed. For example, a respective fixed reference RFID tag (e.g., 750A, 750B, 750C, 750D, etc.) can be attached to one or more (or all) of the four bottom interior corners and/or four top interior of a shopper's basket (e.g., container volume of interest 730).

In one illustrative example, the RFID system 700 can include one or more reference RFID tags each attached to a respective location on and/or within the basket 730. For example, the RFID system 700 can include a first RFID reference tag A 750A attached to an upper left corner of the basket 730, a second RFID reference tag B 750B attached to a lower left corner of the basket 730, a third RFID reference tag C 750C attached to a lower right corner of the basket 730, and a fourth RFID reference tag D 750D attached to an upper right corner of the basket 730. In some examples, the RFID reference tags 750A-750D can be the same as or similar to the RFID tags of any of FIGS. 3-6.

Calibration can be performed based on configuring one or more (or all) of the RFID readers 710-718 (e.g., including primary and/or non-primary RFID readers) within the basket 730, and performing a respective channel (e.g., frequency) hopping-based PBR measurements to determine an estimated RFID ranging value or distance measurement between the respective RFID reader 710-718 and each one of the fixed reference RFID tags 750A-750D. For example, the RFID reader 710 can perform calibration based on a respective RFID ranging measurement with one or more (or all) of a front bottom left reference RFID tag 750B, a front bottom right reference RFID tag 750C, a back bottom left reference RFID tag, a back bottom right reference RFID tag, a front upper left reference RFID tag 750A, a front upper right reference RFID tag 750D, a back upper left reference RFID tag, and/or a back upper right reference RFID tag, etc.

In some aspects, one or more of the RFID readers 710-718 can be attached to and/or integrated with the walls of the container 730. In some examples, one or more of the RFID readers 710-718 is not attached to the container 730, and may be provided as a mobile RFID reader such as a smartphone, UE, or other computing device, etc. In some aspects, the RFID readers 712, 716, and 718 are attached to the sides of the container 730, the RFID reader 714 is attached to the bottom of the container 730, and the RFID reader 710 is a portable RFID reader not attached to the container 730.

In some aspects, the container 730 can be a measurement box or other fixed volume of interest into which a shopper or user can empty the contents of their shopping bag, basket, cart, etc. for item inventory measurement based on the PBR-based channel hopping 2D or 3D localization described herein. For example, when each RFID-tagged item placed within the container volume of interest 730 is detected by the synchronized PBR-based localization with channel hopping synchronization as implemented by the RFID readers 710-718, the corresponding item associated with the RFID tag or unique RFID tag identifier can be added to the item inventory listing information and the corresponding item price can be added to a running or cumulative total for the basket contents.

In some examples, the container 730 can be a shopping bag, basket, cart, etc., or other volume of interest into which RFID-tagged items are placed by a shopper while moving through a store or other retail environment. The plurality of RFID readers 710-718 can be configured to localize and detect the RFID tag of each RFID-tagged item to register the item into the basket contents inventor as the item is placed within the volume of the container 730. In some cases, a current total price for the localized RFID-tagged items within the container 730 volume of interest can be displayed by a mobile application running a smartphone, UE, or mobile computing device of the user that is in communication with the RFID system 700. In some cases, the container 730 can include a handle with an integrated weight sensor, which may be used to determine an actual basket weight for validation against an expected basket weight (e.g., based on the identified and/or localized RFID-tagged items within the basket 730 volume of interest).

In some aspects, the RFID system 700 can be configured to determine the item contents inventory information corresponding to the RFID-tagged items within the volume of interest of the container 730 based on each RFID reader of the plurality of RFID readers 710-718 performing PBR range measurements to all nearby RFID tags (e.g., each RFID reader 710-718 makes a plurality of PBR range measurements to each RFID tag that is within range of and backscatters the carrier signal pilot tone from the respective RFID reader 710-718). The PBR measurements can be performed by each RFID reader based on synchronization of respective carrier frequency (e.g., channel) sequences associated with and configured for each RFID reader 710-718, the same as or similar to that described above with respect to the RFID system 500 of FIG. 5 and/or the RFID system 600 of FIG. 6.

In some aspects, a confidence metric can be determined by each RFID reader 710-718 for a respective PBR range measurement between the RFID reader and one of the plurality of RFID tags 740, 742, 747, . . . , etc. In one illustrative example, when one of the RFID readers 710-718 performs PBR distance estimation to the various RFID tags of FIG. 7, the confidence information corresponding to each respective PBR-based distance estimate can be based on a determined variance of the estimated distance D to the RFID tag. For example, the confidence information can comprise a variance of the PBR-based distance estimate D, according to Eq. (3) above. In some aspects, the confidence information can correspond to a total phase noise associated with the RFID measurements (e.g., PBR measurements) performed between the respective RFID reader of the plurality of RFID readers 710-718 and a particular RFID tag. For example, the confidence information can correspond to a total phase noise that is the same as or similar to the total phase noise σ_{ϵ} of Eq. (3), where σ_{ϵ} represents the total phase noise, which can comprise principal components:

$${σ}_{ϵ}^{2} = {σ}_{ϵ G}^{2} + {σ}_{ϵ V}^{2} .$$

In some aspects, the confidence information for a PBR-based distance estimate D between the RFID reader and a particular RFID tag can correspond to the oscillator-based phase noise variance

$${σ}_{ϵ V}^{2}$$

of Eq. (3), the Gaussian noise-based phase noise variance

$${σ}_{ϵ G}^{2}$$

of Eqs. (3) and (4), and/or can correspond to various combinations thereof.

In some aspects, the confidence information determined for the respective RFID tags can be compared to one or more configured thresholds. For example, the respective RFID reader of the plurality of RFID readers 710-718 can perform a plurality of RFID measurements with a particular RFID tag of FIG. 7 to determine a distance estimate from the RFID reader to the particular RFID tag, as noted above. The RFID reader can additionally determine corresponding confidence information for the distance estimate to the particular RFID tag (e.g., variance information according to one or more of Eqs. (3) and/or (4)).

The confidence information for the distance estimate to each particular RFID tag can be compared to a configured confidence threshold. For example, if the confidence for the distance estimate to an RFID tag is greater than or equal to the configured confidence threshold, the distance estimate can be accepted and used to identify the RFID tag (and/or corresponding RFID tagged item associated with the RFID tag) as being included in the item inventory of the contents of basket 730, or as being not included in the item inventory of the contents of basket 730. If the confidence for the distance estimate to an RFID tag is less than the configured confidence threshold, the distance estimate may be rejected and not used for the localization of the particular or corresponding RFID tag associated with the low-confidence distance estimate from one of the RFID readers 710-718.

RFID tags that correspond to a determination of a relatively short PBR-based ranges or distance estimates to most or all of the RFID readers 710-718 can be identified or localized as being inside the basket 730 volume of interest. For example, the RFID-tagged item associated with RFID tag-A 742 of FIG. 7 measures a relatively short distance to all of the RFID readers 710-718 of the RFID system 700, and can be localized to being inside the basket 730 volume of interest with high confidence.

RFID-tagged items outside the basket 730 volume of interest will record one or more PBR-based distance estimates that are relatively long (e.g., longer than a configured threshold distance known for the container 730 dimensions and/or determined based on the calibration using the RFID reference tags 750A-750D; longer than an average, median, etc., distance determined for the already localized RFID tags measured by the RFID system 700, etc.). In some aspects, RFID tags detected with any “long” PBR-based distance estimates can be identified as being outside the basket 730 volume of interest, and can be excluded from the basket contents item inventory information determined by the RFID system 700. For example, RFID tag-B 747 measures a “long” PBR-based distance estimate from at least the RFID readers 718, 714, and 712 (and may additionally measure a “long” PBR-based distance estimate from the RFID reader 710, or may be undetected by RFID reader 710 based on the RFID tag-B 747 being farther than the maximum detection or PBR ranging distance for the RFID reader 710). The RFID tag-B 747 can measure a “short” PBR-based distance estimate from the RFID reader 716, but is excluded from the container 730 item contents inventory information based on at least one “long” PBR-based distance estimate being determined for the RFID tag-B 747 by at least one other RFID reader of the RFID system 700 besides the RFID reader 716.

In some cases, the RFID system 700 and/or the container 730 can include one or more inertial measurement units (IMUs) that can be used to detect motion of a portable basket used as the container 730. In this example, RFID-tagged items not within the basket 730 volume of interest (e.g., RFID tag-B 747) will be observed to change distance more rapidly and/or with a larger magnitude than any distance changes detected for the RFID tags of the RFID-tagged items within the volume of the basket 730 (e.g., such as RFID tag-A 742, RFID tags 740, etc.). In some cases, one or more passive RFID tags can be provided on the boundary of the container 730 to improve calibration performance.

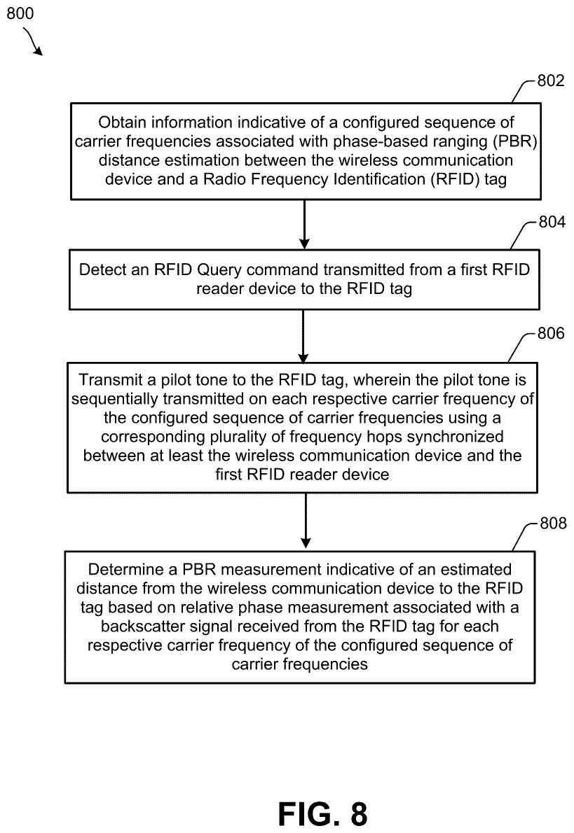

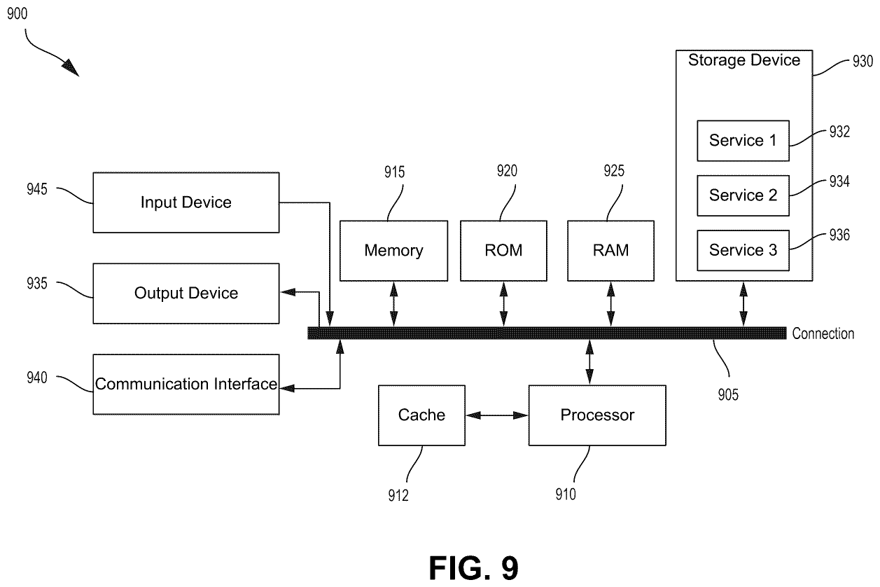

FIG. 8 is a flowchart diagram illustrating an example of a process 800 for wireless communications. In some examples, the process 800 can be performed by a computing device or apparatus or a component or system (e.g., one or more chipsets, one or more processors such as one or more CPUs, DSPs, NPUs, NSPs, microcontrollers, ASICS, FPGAs, programmable logic devices, discrete gates or transistor logic components, discrete hardware components, etc., any combination thereof, and/or other component or system) of the computing device or apparatus. The operations of the process 800 may be implemented as software components that are executed and run on one or more processors (e.g., processor 910 of FIG. 9 or other processor(s)). In some examples, the process 800 can be performed by an RFID reader and/or RFID energizer, such as the RFID reader 310 of FIG. 3, the RFID reader device 410 of FIG. 4A, the RFID reader device 510 of FIG. 5, and/or the RFID reader device 610 of FIG. 6, etc. In some aspects, the process 800 can be performed by a UE, smartphone, mobile computing device, user computer device, etc., that includes and/or implements an RFID reader (e.g., RFID energizer). In some examples, the process 800 can be performed by a computing device that includes an SoC configured to implement and/or including an RFID reader (e.g., RFID energizer). In some cases, the process 800 can be performed by an RFID reader (e.g., RFID energizer) included in or associated with a basket. For instance, the process 800 can be performed by an RFID reader included in or attached to a handheld shopping basket, cart, trolley, etc.

At block 802, the computing device (or component thereof) can obtain information indicative of a configured sequence of carrier frequencies associated with phase-based ranging (PBR) distance estimation between the computing device and a Radio Frequency Identification (RFID) tag. For example, the computing device can be a wireless communication device associated with PBR measurements for the RFID tag. In some examples, the computing device is a wireless communication device comprising an RFID reader device configured to transmit and receive RFID signals. For example, the computing device can be an RFID reader device such as the RFID reader 310 of FIG. 3, 410 of FIG. 4A, 510-518 of FIG. 5, 610-618 of FIG. 6, 710-718 of FIG. 7, etc.

In some cases, the RFID tag can be the same as or similar to the RFID tag 350 of FIG. 3; the RFID tag 442 of FIG. 4A; the RFID tag 540 of FIG. 5, the RFID tag 640 of FIG. 6, one or more of the RFID reference tags 750A-750D of FIG. 7, one or more of the RFID tags 740 and/or 742 and/or 747 of FIG. 7, etc. In some examples, the sequence of carrier frequencies associated with the PBR distance estimation can be based on the carrier frequencies fin the graph 480 of FIG. 4B.

At block 804, the computing device (or component thereof) can detect an RFID Query command transmitted from a first RFID reader device to the RFID tag.

For example, the RFID Query command can be the same as or similar to the transmitted signal 422 of FIG. 4A, the Query command 615 of FIG. 6, etc. In some examples, the first RFID reader device is configured as a primary RFID reader device for a synchronization group comprising a plurality of RFID reader devices including the first RFID reader device and the computing device. The computing device can comprise a second RFID reader device configured as a non-primary RFID reader device associated and synchronized with the first RFID reader device. For example, the primary RFID reader device can be the same as or similar to the primary RFID Reader-1 device 510 of FIG. 5, and the non-primary RFID reader device can be the same as or similar to the non-primary RFID reader device(s) 514, 516, and/or 518 of FIG. 5, etc. In some examples, the primary RFID reader device can be one of the RFID reader devices 710-718 of FIG. 7, and the non-primary RFID reader device can be among the remaining ones of the RFID reader devices 710-718 of FIG. 7.

At block 806, the computing device (or component thereof) can transmit a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device.

For example, the pilot tone can be transmitted as the transmitted signal 422 of FIG. 4, and/or can be transmitted as the sequential transmissions 630, 634, 636, 638, . . . , etc., of FIG. 6. In some cases, the respective carrier frequencies of the configured sequence of carrier frequencies can be based on one or more of the carrier frequency sequence {C₀, C₁, . . . , C_{N-1}} configured for RFID reader 510 of FIG. 5, the carrier frequency sequence {C), . . . , C₁, C₀} configured for RFID reader 514 of FIG. 5, the carrier frequency sequence {C₂, . . . , C_{N-1}, C₀, C₁} configured for RFID reader 516 of FIG. 5, the carrier frequency sequence {C₃, . . . , C_{N-1}, C₀, C₁, C₂} configured for RFID reader 518 of FIG. 5, etc.

In some examples, each RFID reader device included in the plurality of RFID reader devices performs simultaneous frequency hops based on time synchronization of the synchronization group. For example, the RFID reader devices 610-618 can perform simultaneous frequency hopes based on time synchronization of the synchronization group comprising the RFID reader devices 610-618 of FIG. 6. In some cases, each RFID reader device included in the plurality of RFID reader devices is associated with a different sequence order of a set of configured carrier frequencies. For example, the RFID reader device 610 of FIG. 6 is associated with the sequence order 630 of the set of configured carrier frequencies, the RFID reader device 614 is associated with the sequence order 634, the RFID reader device 616 is associated with the sequence order 636, the RFID reader device 618 is associated with the sequence order 638, etc.

In some cases, each RFID reader device included in the plurality of RFID reader devices is associated with a respective sequence of carrier frequencies, and the respective sequences of carrier frequencies for the plurality of RFID reader devices are orthogonal to one another. In some examples, each RFID reader device transmits the pilot tone using a unique sequence order of a same set of carrier frequencies shared across the plurality of RFID reader devices.

At block 808, the computing device (or component thereof) can determine a PBR measurement indicative of an estimated distance from the wireless communication device to the RFID tag based on relative phase measurement associated with a backscatter signal received from the RFID tag for each respective carrier frequency of the configured sequence of carrier frequencies.

In some cases, the computing device (or component thereof) can be further configured to determine a location estimate of the RFID tag using at least the PBR measurement indicative of the estimated distance from the wireless communication device to the RFID tag, and an additional PBR measurement received from the first RFID reader device and indicative of an estimated distance from the first RFID reader device to the RFID tag. In some cases, the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices. In some cases, the plurality of RFID reader devices includes the wireless communication device and the first RFID reader device.

The network entity, network device, and/or the wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 800 of FIG. 8 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed by the disclosed systems and techniques. In particular, FIG. 9 illustrates an example of computing system 900, which can be, for example, any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A wireless communication device for wireless communications, the wireless communication device comprising: at least one memory; and at least one processor coupled to the at least one memory and configured to: obtain information indicative of a configured sequence of carrier frequencies associated with phase-based ranging (PBR) distance estimation between the wireless communication device and a Radio Frequency Identification (RFID) tag; detect an RFID Query command transmitted from a first RFID reader device to the RFID tag; transmit a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and determine a PBR measurement indicative of an estimated distance from the wireless communication device to the RFID tag based on relative phase measurement associated with a backscatter signal received from the RFID tag for each respective carrier frequency of the configured sequence of carrier frequencies.
Aspect 2. The wireless communication device of Aspect 1, wherein the at least one processor is further configured to: determine a location estimate of the RFID tag using at least the PBR measurement indicative of the estimated distance from the wireless communication device to the RFID tag, and an additional PBR measurement received from the first RFID reader device and indicative of an estimated distance from the first RFID reader device to the RFID tag.
Aspect 3. The wireless communication device of Aspect 2, wherein: the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices.
Aspect 4. The wireless communication device of Aspect 3, wherein the plurality of RFID reader devices includes the wireless communication device and the first RFID reader device.
Aspect 5. The wireless communication device of any of Aspects 1 to 4, wherein the wireless communication device comprises an RFID reader device configured to transmit and receive RFID signals.
Aspect 6. The wireless communication device of Aspect 5, wherein: the first RFID reader device is configured as a primary RFID reader device for a synchronization group comprising a plurality of RFID reader devices including the first RFID reader device and the wireless communication device; and the wireless communication device comprises a second RFID reader device configured as a non-primary RFID reader device associated and synchronized with the first RFID reader device.
Aspect 7. The wireless communication device of Aspect 6, wherein each RFID reader device included in the plurality of RFID reader devices performs simultaneous frequency hops based on time synchronization of the synchronization group.
Aspect 8. The wireless communication device of Aspect 7, wherein each RFID reader device included in the plurality of RFID reader devices is associated with a different sequence order of a set of configured carrier frequencies.
Aspect 9. The wireless communication device of any of Aspects 7 to 8, wherein each RFID reader device included in the plurality of RFID reader devices is associated with a respective sequence of carrier frequencies, and wherein the respective sequences of carrier frequencies for the plurality of RFID reader devices are orthogonal to one another.
Aspect 10. The wireless communication device of any of Aspects 8 to 9, wherein each RFID reader device transmits the pilot tone using a unique sequence order of a same set of carrier frequencies shared across the plurality of RFID reader devices.
Aspect 11. A method for wireless communications, the method comprising: obtaining information indicative of a configured sequence of carrier frequencies associated with phase-based ranging (PBR) distance estimation between a wireless communication device and a Radio Frequency Identification (RFID) tag; detecting an RFID Query command transmitted from a first RFID reader device to the RFID tag; transmitting a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and determining a PBR measurement indicative of an estimated distance from the wireless communication device to the RFID tag based on relative phase measurement associated with a backscatter signal received from the RFID tag for each respective carrier frequency of the configured sequence of carrier frequencies.
Aspect 12. The method of Aspect 11, further comprising: determining a location estimate of the RFID tag using at least the PBR measurement indicative of the estimated distance from the wireless communication device to the RFID tag, and an additional PBR measurement received from the first RFID reader device and indicative of an estimated distance from the first RFID reader device to the RFID tag.
Aspect 13. The method of Aspect 12, wherein: the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices.
Aspect 14. The method of Aspect 13, wherein the plurality of RFID reader devices includes the wireless communication device and the first RFID reader device.
Aspect 15. The method of any of Aspects 11 to 14, wherein the wireless communication device comprises an RFID reader device configured to transmit and receive RFID signals.
Aspect 16. The method of Aspect 15, wherein: the first RFID reader device is configured as a primary RFID reader device for a synchronization group comprising a plurality of RFID reader devices including the first RFID reader device and the wireless communication device; and the wireless communication device comprises a second RFID reader device configured as a non-primary RFID reader device associated and synchronized with the first RFID reader device.
Aspect 17. The method of Aspect 16, wherein each RFID reader device included in the plurality of RFID reader devices performs simultaneous frequency hops based on time synchronization of the synchronization group.
Aspect 18. The method of Aspect 17, wherein each RFID reader device included in the plurality of RFID reader devices is associated with a different sequence order of a set of configured carrier frequencies.
Aspect 19. The method of any of Aspects 17 to 18, wherein each RFID reader device included in the plurality of RFID reader devices is associated with a respective sequence of carrier frequencies, and wherein the respective sequences of carrier frequencies for the plurality of RFID reader devices are orthogonal to one another.
Aspect 20. The method of any of Aspects 18 to 19, wherein each RFID reader device transmits the pilot tone using a unique sequence order of a same set of carrier frequencies shared across the plurality of RFID reader devices.
Aspect 21. A non-transitory computer-readable medium having code stored thereon that, when executed by an apparatus, causes the apparatus to: obtain information indicative of a configured sequence of carrier frequencies associated with phase-based ranging (PBR) distance estimation between the apparatus and a Radio Frequency Identification (RFID) tag; detect an RFID Query command transmitted from a first RFID reader device to the RFID tag; transmit a pilot tone to the RFID tag, wherein the pilot tone is sequentially transmitted on each respective carrier frequency of the configured sequence of carrier frequencies using a corresponding plurality of frequency hops synchronized between at least the apparatus and the first RFID reader device; and determine a PBR measurement indicative of an estimated distance from the apparatus to the RFID tag based on relative phase measurement associated with a backscatter signal received from the RFID tag for each respective carrier frequency of the configured sequence of carrier frequencies.
Aspect 22. The non-transitory computer-readable medium of Aspect 21, wherein the code, when executed by the apparatus, further causes the apparatus to: determine a location estimate of the RFID tag using at least the PBR measurement indicative of the estimated distance from the apparatus to the RFID tag, and an additional PBR measurement received from the first RFID reader device and indicative of an estimated distance from the first RFID reader device to the RFID tag.
Aspect 23. The non-transitory computer-readable medium of Aspect 22, wherein: the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices.
Aspect 24. The non-transitory computer-readable medium of Aspect 23, wherein the plurality of RFID reader devices includes the apparatus and the first RFID reader device.
Aspect 25. The non-transitory computer-readable medium of any of Aspects 21 to 24, wherein the apparatus comprises an RFID reader device configured to transmit and receive RFID signals.
Aspect 26. The non-transitory computer-readable medium of Aspect 25, wherein: the first RFID reader device is configured as a primary RFID reader device for a synchronization group comprising a plurality of RFID reader devices including the first RFID reader device and the apparatus; and the apparatus comprises a second RFID reader device configured as a non-primary RFID reader device associated and synchronized with the first RFID reader device.
Aspect 27. The non-transitory computer-readable medium of Aspect 26, wherein each RFID reader device included in the plurality of RFID reader devices performs simultaneous frequency hops based on time synchronization of the synchronization group.
Aspect 28. The non-transitory computer-readable medium of Aspect 27, wherein each RFID reader device included in the plurality of RFID reader devices is associated with a different sequence order of a set of configured carrier frequencies.
Aspect 29. The non-transitory computer-readable medium of any of Aspects 27 to 28, wherein each RFID reader device included in the plurality of RFID reader devices is associated with a respective sequence of carrier frequencies, and wherein the respective sequences of carrier frequencies for the plurality of RFID reader devices are orthogonal to one another.
Aspect 30. The non-transitory computer-readable medium of any of Aspects 28 to 29, wherein each RFID reader device transmits the pilot tone using a unique sequence order of a same set of carrier frequencies shared across the plurality of RFID reader devices.
Aspect 31. A method for wireless communication, comprising performing operations according to any of Aspects 1 to 10 or 21 to 30.
Aspect 32. A non-transitory computer-readable storage medium comprising instructions stored thereon which, when executed by at least one processor, causes the at least one processor to perform operations according to any of Aspects 1 to 10 or 11 to 20.
Aspect 33. An apparatus for wireless communication comprising one or more means for performing operations according to any of Aspects 1 to 10.
Aspect 34. An apparatus for wireless communication comprising one or more means for performing operations according to any of Aspects 11 to 20.
Aspect 35. An apparatus for wireless communication comprising one or more means for performing operations according to any of Aspects 21 to 30.

1. A wireless communication device for wireless communications, the wireless communication device comprising:
at least one memory; and
at least one processor coupled to the at least one memory and configured to:
obtain information indicative of a configured sequence of carrier frequencies associated with phase-based ranging (PBR) distance estimation between the wireless communication device and a Radio Frequency Identification (RFID) tag;
detect an RFID Query command transmitted from a first RFID reader device to the RFID tag;
transmit a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and
determine a PBR measurement indicative of an estimated distance from the wireless communication device to the RFID tag based on relative phase measurement associated with a backscatter signal received from the RFID tag for each respective carrier frequency of the configured sequence of carrier frequencies.

2. The wireless communication device of claim 1, wherein the at least one processor is further configured to:
determine a location estimate of the RFID tag using at least the PBR measurement indicative of the estimated distance from the wireless communication device to the RFID tag, and an additional PBR measurement received from the first RFID reader device indicative of an estimated distance from the first RFID reader device to the RFID tag.

3. The wireless communication device of claim 2, wherein:
the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices.

4. The wireless communication device of claim 3, wherein;
the first RFID reader device is included in the plurality of RFID reader devices; and
the wireless communication device is a second RFID reader device included in the plurality of RFID reader devices.

5. The wireless communication device of claim 1, wherein the wireless communication device is a second RFID reader device configured to transmit and receive RFID signals, the second RFID reader device different from the first RFID reader device.

6. The wireless communication device of claim 5, wherein:
the first RFID reader device is configured as a primary RFID reader device of a synchronization group comprising a plurality of RFID reader devices; and
the second RFID reader device is configured as a non-primary RFID reader device of the synchronization group, wherein the plurality of RFID reader devices includes at least the first RFID reader device and the second RFID reader device, and wherein the second RFID reader device is associated and synchronized with the first RFID reader device.

7. The wireless communication device of claim 6, wherein each RFID reader device included in the plurality of RFID reader devices performs simultaneous frequency hops based on time synchronization of the synchronization group.

8. The wireless communication device of claim 7, wherein each RFID reader device included in the plurality of RFID reader devices is associated with a different sequence order of a set of configured carrier frequencies.

9. The wireless communication device of claim 7, wherein each RFID reader device included in the plurality of RFID reader devices is associated with a respective sequence of carrier frequencies, and wherein the respective sequences of carrier frequencies for the plurality of RFID reader devices are orthogonal to one another.

10. The wireless communication device of claim 8, wherein each RFID reader device transmits the pilot tone using a unique sequence order of a same set of carrier frequencies shared across the plurality of RFID reader devices.

11. A method for wireless communications, the method comprising:
obtaining information indicative of a configured sequence of carrier frequencies associated with phase-based ranging (PBR) distance estimation between a wireless communication device and a Radio Frequency Identification (RFID) tag;
detecting an RFID Query command transmitted from a first RFID reader device to the RFID tag;
transmitting a pilot tone to the RFID tag, wherein the pilot tone is sequentially transmitted on each respective carrier frequency of the configured sequence of carrier frequencies using a corresponding plurality of frequency hops synchronized between at least the wireless communication device and the first RFID reader device; and
determining a PBR measurement indicative of an estimated distance from the wireless communication device to the RFID tag based on relative phase measurement associated with a backscatter signal received from the RFID tag for each respective carrier frequency of the configured sequence of carrier frequencies.

12. The method of claim 11, further comprising:
determining a location estimate of the RFID tag using at least the PBR measurement indicative of the estimated distance from the wireless communication device to the RFID tag, and an additional PBR measurement received from the first RFID reader device indicative of an estimated distance from the first RFID reader device to the RFID tag.

13. The method of claim 12, wherein:
the location estimate of the RFID tag comprises a two-dimensional (2D) or a three-dimensional (3D) location estimate determined based on carrier parallelism between a plurality of PBR measurements obtained using synchronized frequency hops associated with a plurality of RFID reader devices.

14. The method of claim 13, wherein;
the first RFID reader device is included in the plurality of RFID reader devices; and
the wireless communication device is a second RFID reader device included in the plurality of RFID reader devices.

15. The method of claim 11, wherein the wireless communication device is a second RFID reader device configured to transmit and receive RFID signals, the second RFID reader device different from the first RFID reader device.

16. The method of claim 15, wherein:
the first RFID reader device is configured as a primary RFID reader device of a synchronization group comprising a plurality of RFID reader devices; and
the second RFID reader device is configured as a non-primary RFID reader device of the synchronization group, wherein the plurality of RFID reader devices includes at least the first RFID reader device and the second RFID reader device, and wherein the second RFID reader device is associated and synchronized with the first RFID reader device.

17. The method of claim 16, wherein each RFID reader device included in the plurality of RFID reader devices performs simultaneous frequency hops based on time synchronization of the synchronization group.

18. The method of claim 17, wherein each RFID reader device included in the plurality of RFID reader devices is associated with a different sequence order of a set of configured carrier frequencies.

19. The method of claim 17, wherein each RFID reader device included in the plurality of RFID reader devices is associated with a respective sequence of carrier frequencies, and wherein the respective sequences of carrier frequencies for the plurality of RFID reader devices are orthogonal to one another.

20. A non-transitory computer-readable medium having code stored thereon that, when executed by an apparatus, causes the apparatus to:
obtain information indicative of a configured sequence of carrier frequencies associated with phase-based ranging (PBR) distance estimation between the apparatus and a Radio Frequency Identification (RFID) tag;
detect an RFID Query command transmitted from a first RFID reader device to the RFID tag;
transmit a pilot tone to the RFID tag, wherein the pilot tone is sequentially transmitted on each respective carrier frequency of the configured sequence of carrier frequencies using a corresponding plurality of frequency hops synchronized between at least the apparatus and the first RFID reader device; and
determine a PBR measurement indicative of an estimated distance from the apparatus to the RFID tag based on relative phase measurement associated with a backscatter signal received from the RFID tag for each respective carrier frequency of the configured sequence of carrier frequencies.
